(19) United States
(12) Patent Application Publication
(10) Pub. No.: US 2012/0085045 A1
(43) Pub. Date: Apr. 12, 2012

(54) DOOR FRAME SECURITY PIECES AND SYSTEM

(76) Inventor: Jorge TORRES, North York (CA)

(21) Appl. No.: 13/079,950

(22) Filed: Apr. 5, 2011

(30) Foreign Application Priority Data
Apr. 12, 2010 (CA) 2699704

(51) Int. Cl. E04B 1/92; E06B 1/52; E04C 2/38; E05B 17/00

(52) U.S. Cl. 52/204.1; 70/431; 52/656.4; 52/741.3

(57) ABSTRACT

The present invention is in a first part is a door security system including an elongate J-frame to attach to a door-frame having a recessed groove defined within a first vertical piece. The J-frame snugly nestles within, and extends entirely along the groove. An elongate vertical member attaches to a door first vertical surface to entirely cover same and traverse at least the door thickness. The vertical member mates with the J-frame, to prevent unwanted force entry. In a second part, the invention includes an elongate U-frame to attach to a door having a recessed groove defined within a second vertical surface. The U-frame snugly nestles within and extends entirely along the recessed groove. An elongate T-frame attaches to, and extends axially entirely along, a second vertical door-frame piece. The T-frame mates with the U-frame to prevent the door from being removed from its frame.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to doors and door frames, and more specifically, to pieces for attachment to doors and door frames to resist forcible entry.

2. Description of Related Art Including Information Disclosed Under 37 CFR 1.97 and 37 CFR 1.98

It has been estimated that door locks have existed for as much as four thousand years. This long history underscores the importance people have placed on preventing unwanted, and in many cases forcible, entry onto their premises, through any given door.

Prior art is replete with various systems for preventing such unwanted and forcible entry, including standard key-tumbler locks, pin and hole locks, wedges, and modern electronic security alarms. Most of these prior art systems, however, fail when excessive physical force is applied to a given door or frame by, for example, battering rams. Other lock systems can be overcome simply by removing door hinges and lifting a door away from its frame.

### SUMMARY OF THE INVENTION

In one preferred embodiment, the present invention is a door-frame security piece comprising an elongate J-frame to attach to a door-frame. The door-frame has a) a first and second vertical piece each of a pre-defined door-length, b) a first horizontal piece of a pre-defined door-width, and c) a recessed groove defined within the first vertical piece and extending axially therealong. The J-frame is shaped and dimensioned to snugly nestle within and extend entirely along the recessed groove. The J-frame is positionable to allow a door to freely open and close within said door-frame when the J-channel is nestled in the door-frame groove.

In another preferred embodiment, the present invention is a door security piece comprising an elongate vertical member to attach to a door. The door has a) a first and second vertical surface each being a pre-defined door length, each defining two vertical edge boundaries, b) a first and second horizontal surface being a pre-defined door width, and c) each vertical surface vertical edge boundaries define a door thickness. The elongate member is attachable to the door first vertical surface to entirely cover same and traverse at least the door thickness.

In yet another preferred embodiment, the present invention is a door security piece comprising an elongate U-frame to attach to a door. The door has a) a first and second vertical surface each of a pre-defined door-length, each defining two vertical edge boundaries, b) a first and second horizontal surface each of a pre-defined door-width, c) a recessed groove defined within the second vertical surface extending axially therealong, and d) each vertical surface vertical edge boundaries define a door thickness. The U-frame is shaped and dimensioned to snugly nestle within and extend entirely along the recessed groove. The U-frame is positionable to allow the door within the door frame to freely open and close when the U-frame is nestled in the door recessed groove.

In still yet another preferred embodiment, the present invention is a door-frame security piece comprising an elongate T-frame to attach to a door-frame. The door-frame has a) a first and second vertical piece each of a pre-defined door-length, and b) a first horizontal piece of a pre-defined door-width. The T-frame is positionable to extend axially entirely along the second vertical door-frame piece.

In still yet another preferred embodiment the present invention is a door security system comprising an elongate J-frame to attach to a door-frame. The door-frame has a) a first and second vertical piece each of a pre-defined door-length, b) a first horizontal piece of a pre-defined door-width, and c) a recessed groove defined within the first vertical piece extending axially therealong. The J-frame is shaped and dimensioned to snugly nestle within and extend entirely along said recessed groove. The J-frame is positionable to allow a door to freely open and close within said door-frame when the J-channel is nestled in the door-frame groove. The door has a) a first and second vertical surface each being a pre-defined door length, each defining two vertical edge boundaries, b) a first and second horizontal surface being a pre-defined door width, and c) each vertical surface vertical edge boundaries define a door thickness. An elongate vertical member attaches to the door first vertical surface to entirely cover same and traverse at least the door thickness.

In still yet another preferred embodiment the present invention is a door security system comprising an elongate U-frame to attach to a door. The door has a) a first and second vertical surface each of a pre-defined door-length, each defining two vertical edge boundaries, b) a first and second horizontal surface each of a pre-defined door-width, c) a recessed groove defined within the second vertical surface extending axially therealong, and d) each vertical surface vertical edge boundaries define a door thickness. The U-frame is shaped and dimensioned to snugly nestle within and extend entirely along the recessed groove. The U-frame is positionable to allow the door to freely open and close within a door frame when the U-frame is nestled in the door recessed groove. An elongate T-frame attaches to the door-frame. The door-frame has a) a first and second vertical piece each of the pre-defined door-length, and b) a first horizontal piece of the pre-defined door-width. The T-frame is positionable to extend axially entirely along the second vertical door-frame piece.

In still yet another preferred embodiment, the present invention is use of an elongate J-frame in a door-security system to prevent forcible entry wherein the elongate J-frame is nestled into a door-frame recessed groove axially traversing a door-frame vertical surface, with the J-frame extending entirely along the recessed groove.

In still yet another preferred embodiment the present invention is use of an elongate vertical member in a door-security system to prevent forcible entry wherein the elongate vertical member is attached to a door vertical surface, entirely covering and traversing same.

In still yet another preferred embodiment the present invention is use of an elongate U-frame in a door-security system to prevent forcible entry wherein the U-frame is nestled into a door recessed groove axially traversing a door vertical surface, with the U-frame extending entirely along the recessed groove.

In still yet another preferred embodiment the present invention is use of an elongate T-frame in a door-security system to prevent forcible entry wherein the T-frame extends axially entirely along a door-frame vertical piece.

### BRIEF DESCRIPTION OF THE DRAWINGS

FIG. 1 is a perspective view of a door security system using an elongate J-frame, elongate vertical member, elongate T-frame and elongate U-frame.

FIG. 2 is a cross-sectional view along the line 2-2 in FIG. 1.

FIG. 3 is a perspective view of a partial elongate J-frame.

FIG. 4 is a perspective view of a partial elongate vertical member as a F-frame.

FIG. 5 is another perspective view of a partial elongate vertical member as a F-frame, with deadbolt guide plates attached.

FIG. 6 is an exploded perspective view showing a door, F-frame and J-frame, for attachment to a wooden door-frame.

FIG. 7 is a cross-sectional view of a variant of FIG. 2, showing an F-frame instead of a plain elongate vertical member, all for attachment to a wooden door-frame.

FIG. 8 an exploded perspective view showing a door, F-frame, sleeve and bracket combination, for attachment to a steel door-frame.

FIG. 9 is a cross-sectional view of a variant of FIG. 2, showing an F-frame instead of a plain elongate vertical member, and a sleeve and bracket combination instead of a J-frame, all for attachment for a steel door-frame.

FIG. 10 is a cross-sectional view of an embodiment of a door security system using an elongate hook member, elongate L-bar member, and two flat bars.

FIG. 11 includes elevation views of a simplified bracket for attachment to a steel door-frame.

### DETAILED DESCRIPTION OF THE DRAWINGS

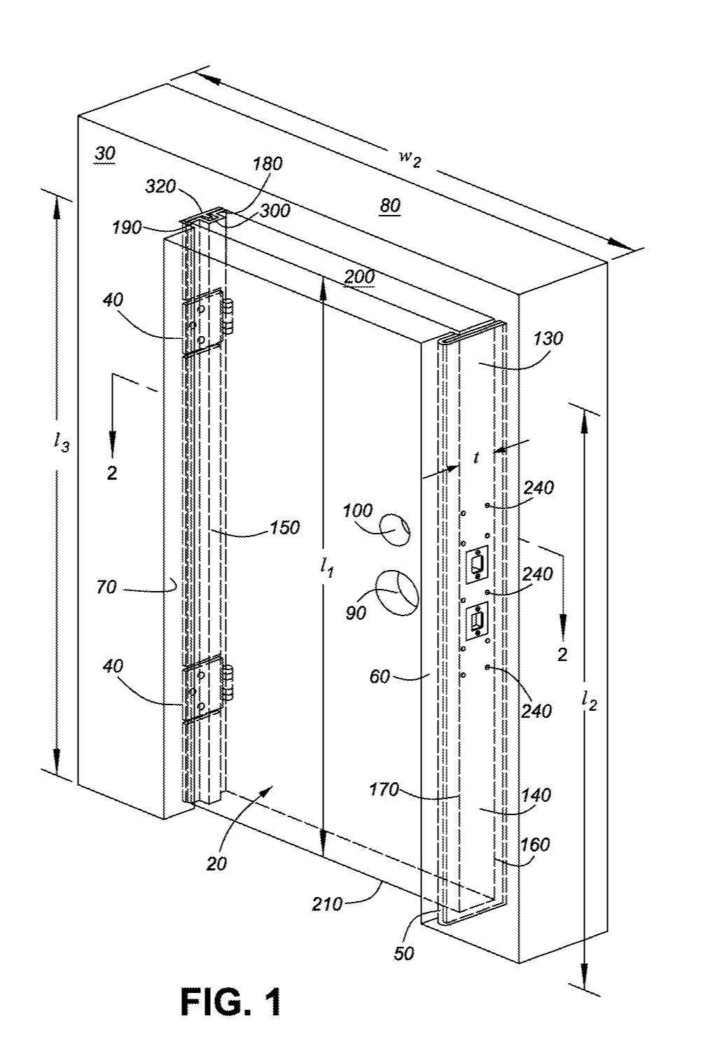

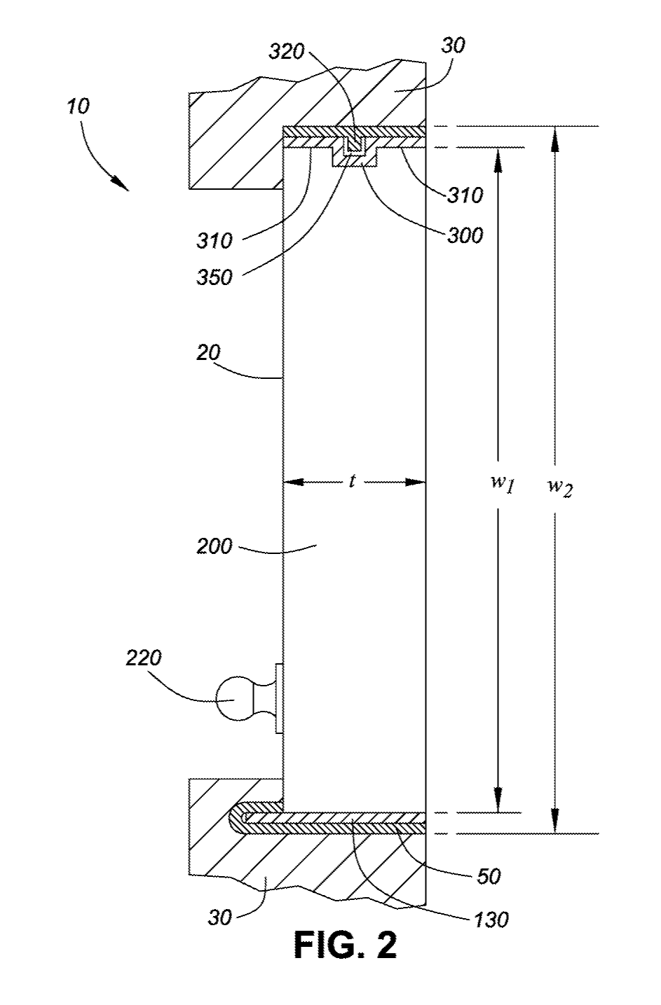

The present invention is a door security system (10) shown best generally in FIG. 2. The system is generally comprised of four separate pieces for use between a door (20) and a door-frame (30). The system (10) can be considered in two separate parts—a first being a part which deals with a door (20) on a side (meaning at vertical surface (140)) where deadbolts (not shown) and door knobs (220) are provided, and a second part opposite to the first (meaning at vertical surface (150) (FIG. 1)), where door hinges (40) are provided. The present invention is suitable for doors (20) and door-frames (30) of any material, and in particular, steel or wood. Moreover, the present invention can be fitted to a door (20) and door-frame (30) combination of any size, regardless of whether the door is for residential purpose, commercial purpose, or any other purpose (provided it is door within a door frame and having two opposing vertical surfaces (140, 150) running generally straight).

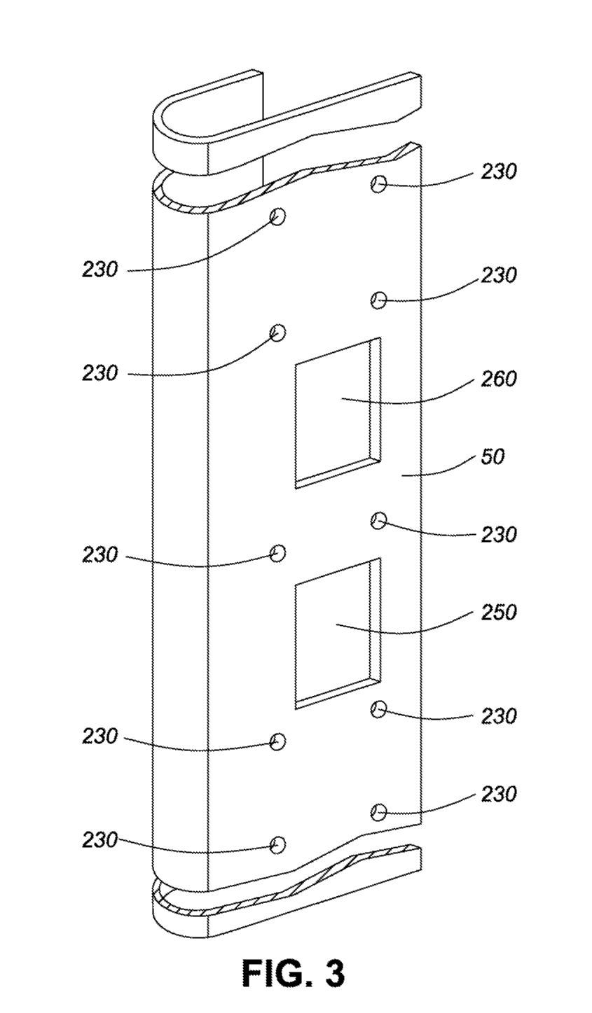

In the present system (10) first part, there is provided an elongate J-frame (50), which is best seen in FIG. 3. To understand how the J-frame (50) works, it is necessary to fictionally divide both the door (20) and door-frame (30) into component pieces.

Examining the door-frame (30) first, the door-frame (30) is considered to have a first (60) and second (70) vertical piece (spanning the length indicator arrow l2 and l3 respectively) each of a pre-defined door (20) length (that is, l2 and l3 are equal in length to the length indicator arrow l1), and a first horizontal piece (80) of a pre-defined door (20) width (spanning the width indicator arrow w2). The horizontal piece (80) bridges the two vertical pieces (60, 70) to define a frame (30) for fitting a door (20) therein. In traditional wooden door-frames (30), said frames (30) are usually outlined by a moulding (not shown) for decorative purpose. The length indicator arrows 12 and 13 refer to an inner portion of the door frame (30), namely that portion which is immediately adjacent the door (20).

The first vertical piece (60) is a side which ultimately will interface with a door (20) deadbolt (not shown) and door knob (220). The second vertical piece (70) is a side which ultimately will interface with door hinges (40). The first vertical piece (60) defines a recessed groove extending axially therealong (meaning the groove runs in a direction indicated by length indicator arrow l1). A door frame (30) first vertical piece (60) can either be pre-fabricated to provide said recessed groove therein, or in an existing piece (60) the groove can be cut out using a router (a power tool with a shaped cutter, used in carpentry for cutting grooves—not shown).

The recessed groove is shaped, positioned, and dimensioned along the first vertical piece (60) to receive the elongate J-frame (50) snugly within. That is, a hook portion of the J-frame (50) nestles within the recessed groove, and the remainder of the J-frame aligns with and runs along the vertical piece (60). A mating arrangement between the elongate J-frame (50) and the first vertical piece (60) is best shown in FIG. 2. The hook portion of the J-frame (50) does not interfere with the door (20) closing, and likewise the J-frame (50) does not extend outwardly beyond the door frame (30), but rather lies flush therewith so as to not interfere with both door-frame (30) aesthetics or functionality (nor does it interfere with door (20) function). That is, the J-frame (50) is positionable to allow the door (20) to freely open and close within the door-frame (30) when the J-channel (50) is nestled in the door-frame (30) groove. For a purpose of strength, durability, and resistance to force-entry, the J-channel (50) should be made of a (relatively) strong steel composition. To securely affix or attach the J-channel (50) to the door-frame (30), the J-frame (50) can define a series of openings (230) for fasteners (not shown; like threaded screws or nails) to pass therethrough.

The J-frame (50) also provides a door knob bolt cut out (250) and at least one dead bolt cut out (260), to permit standard door locking arrangement. Other types of cut outs can be provided, depending on door locking need.

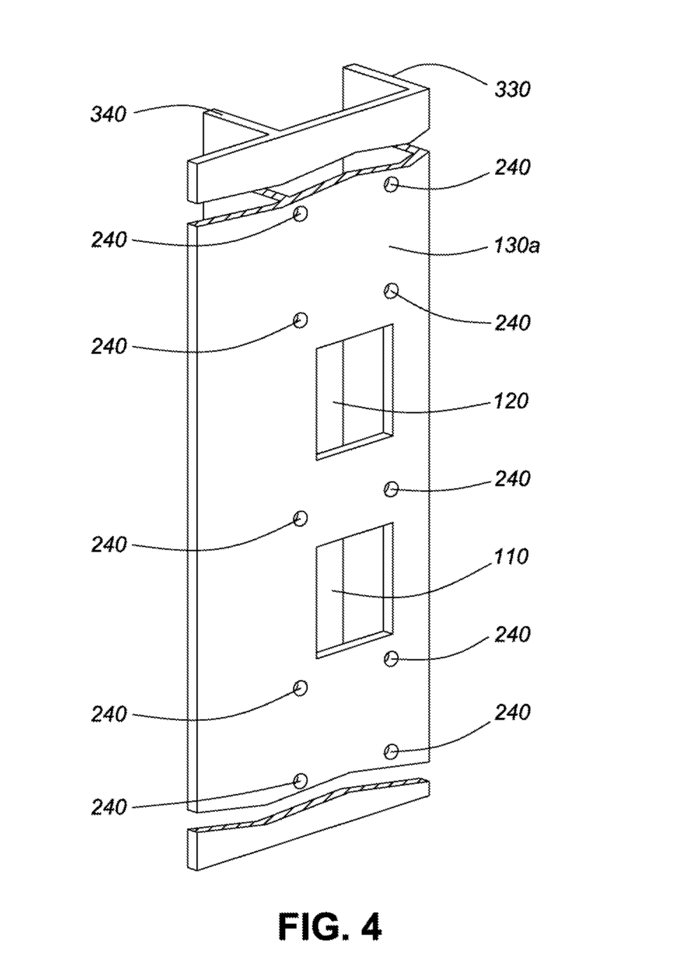

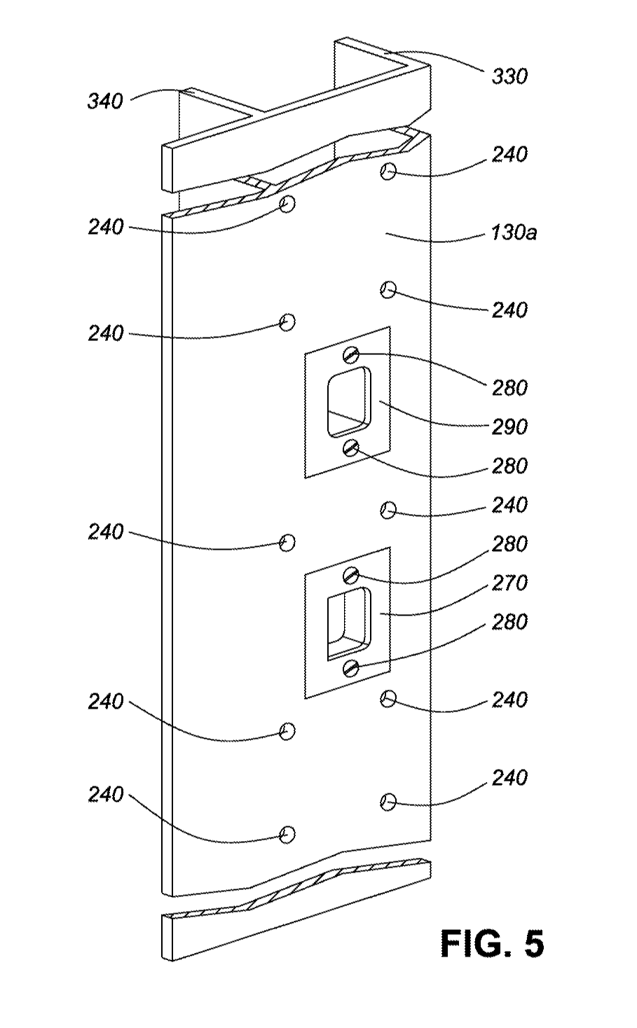

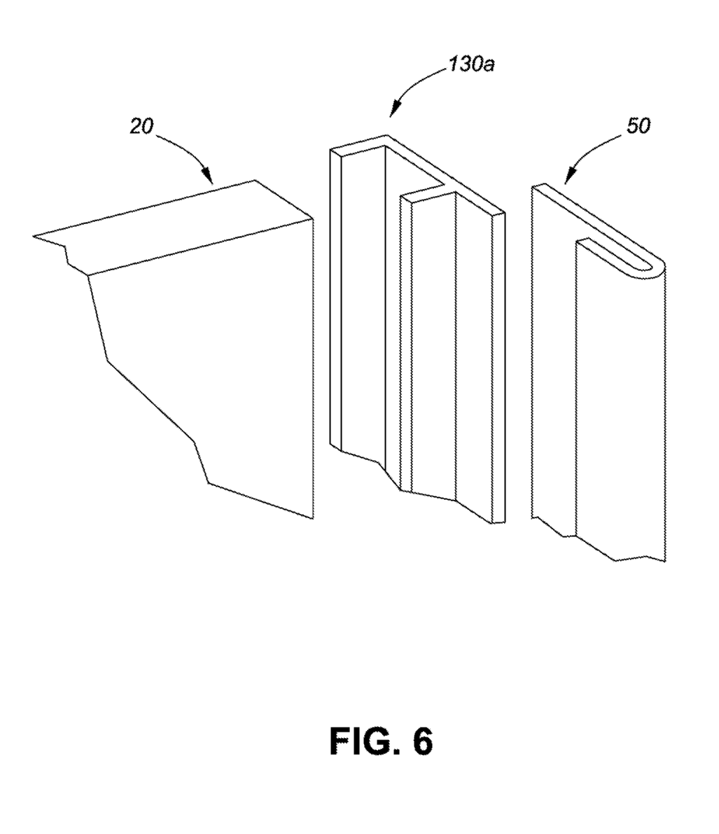

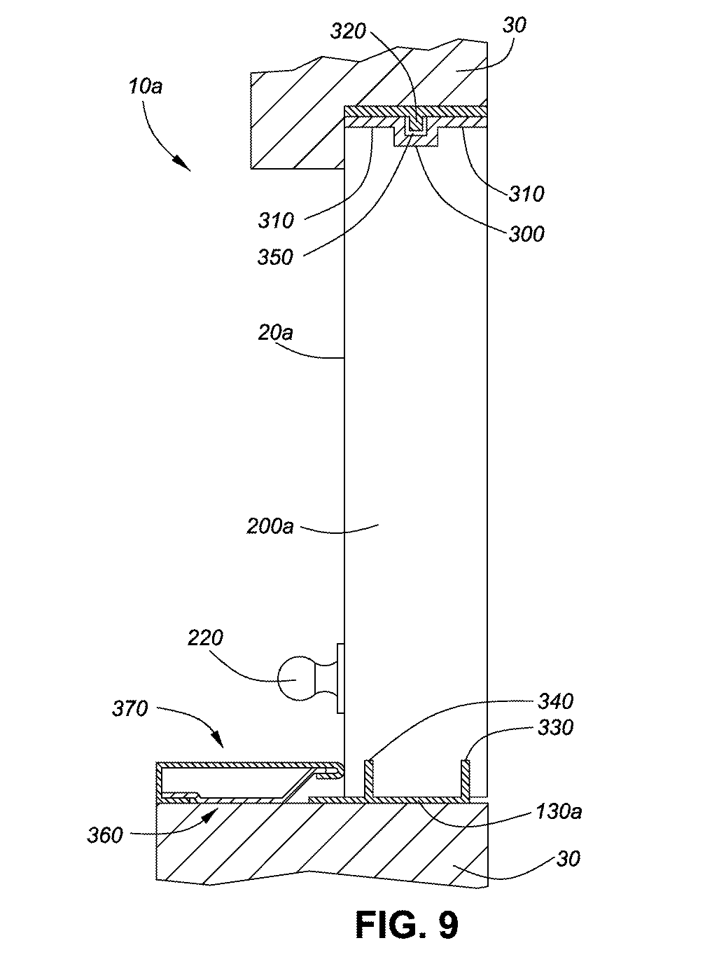

Continuing to examine the first part of this security system, the J-frame (50) interacts with an elongate vertical member (130). This vertical member (130) is best seen in FIGS. 4 and 5, and therein is presented as an F-frame (130a) (meaning shaped like a letter “F”). This member can likewise be shaped as a letter “U”, a “T” or an “L” depending on need and desire. Of all possible configurations, the “F” (130) shape may be best for ensuring resistance to force-entry. FIG. 1 shows the vertical member (130) as being plain, without any “arms” to grasp or surround the door (20). The vertical member (130) can also have two arms (330, 340) as shown in FIGS. 4 and 5), to form an “F” (130a) configuration. The arms (330, 340) can surround, embrace, and attach to a portion of the door (20) (see FIG. 6) for added security. Alternatively, the arms (330, 340) can be embedded (FIG. 9) into the door (20), as a user chooses during installation. To understand exactly how the vertical member (130) works, it is first necessary to fictionally describe the door (20) in terms of component pieces (that is, doors (20) normally are one solid piece, but for explanatory purpose, herein will be described as being constituted from multiple separate pieces or aspects). The door (20) has a first (140) and second (150) vertical surface, each being a pre-defined door length (indicated by length indicator arrow l1). Although residential doors (20) tend to be a standard length, doors (20) can vary in length according to need. Each door vertical surface (140, 150) defines two vertical edge boundaries—on the first vertical surface (140) these boundaries are indicated by reference numerals (160) and (170), and on the second vertical surface (150) these two boundaries are indicated by reference numerals (180) and (190). The “top” and “bottom” of the door (20) respectively have a first (200) and second (210) horizontal surface being a pre-defined door width (spanning the width indicator arrow w1). Each of the vertical surface (140, 150) vertical edge boundaries ((160, 170); (180, 190) respectively) define the door (20) “thickness” (indicated in FIG. 1 by the reference arrow t). In any standard door, typically the thickness between (160) and (170) will be the same as between (180) and (190).

The elongate member (130) is attachable to the door (20) first vertical surface (140), to entirely cover same and traverse at least the door thickness (t). In that sense, the elongate member (130) essentially envelopes the first vertical surface (140). The member (130) can be attached to the door (20) by fasteners (like threaded screws or nails—not shown). In such an embodiment, the member (130) defines openings (240) to pass fasteners (not shown) therethrough.

In most embodiments it will be preferable that the elongate member (130) spans beyond the door thickness (t) such that one edge of the member (130) lies flush with one of the door (20) vertical edge boundaries (160), and the other edge of the member (130) extends beyond the other door (20) vertical edge boundary (170) such that the member (130) extends into the hook portion of the J-frame (50) nestled within the recessed groove. In this sense, the elongate member (130) mates with the J-frame (50) to form a tight barrier. By forming this barrier, it makes it more difficult for someone to pry open the door (20) using, for example, a crowbar (not shown). As the crowbar (not shown) cannot be jammed into any opening between the door (20) and the door-frame (30), an unwanted entrant cannot gain physical leverage and thereby pry the door (20) open from its frame (30).

The elongate member (130) also provides a door knob bolt cut out (110) and at least one dead bolt cut out (120), to permit standard door locking arrangement. Other types of cut outs can be provided, depending on door locking need. The door knob bolt cut out (110) can be fitted with a standard door knob bolt bracket (270) (typically affixed by screws (280)), and can likewise provide at least one dead bolt bracket (290) (typically affixed by screws (280)). These brackets (270, 290) protect door (20) and door-frame (30) integrity, and help guide door knob bolts (not shown) and dead bolts (not shown) from the door (20) into the door-frame (30).

When this system is completely assembled, the elongate member (130) door knob bolt cut out (110) and at least one dead bolt cut out (120) align with the J-frame (50) door knob bolt cut out (250) and at least one dead bolt cut out (260), respectively.

In the present system (10) the system second part there is provided an elongate U-frame (300) (best seen in FIG. 2). Like the J-frame (50) and the elongate member (130), for the purpose of strength, durability, and resistance to force-entry, it should be made of a (relatively) strong steel composition. This elongate U-frame (300) attaches to the door (20) second vertical surface (150) as follows. The door second vertical surface (150) defines a recessed groove extending axially therealong (meaning the groove runs in a direction indicated by length indicator arrow l1). This groove is best seen in FIG. 2. The door (20) second vertical piece (150) can either be pre-fabricated to provide said recessed groove therein, or in an existing piece (150) the groove can be cut out using a router. The recessed groove is disposed roughly midway between the vertical piece (150) vertical edge boundaries (180, 190), but can be positioned anywhere between said boundaries (180, 190), provided door (20) integrity and function is not compromised. The U-frame (300) is shaped and dimensioned to snugly nestle within and extend entirely along the recessed groove, much as the J-frame (50) is shaped and dimensioned to snugly nestle within its corresponding groove in the door-frame (30). The U-frame (300) is positionable to allow the door (20) (within the door frame (30)) to freely open and close when the U-frame (300) is nestled in the door (20) recessed groove.

For better strength and security, the U-frame (300) is further comprised of wings (310) attached to the U-frame (300). Ideally, the U-frame (300) and wings (310) are integrated into one single solid piece (as opposed to three separate pieces welded or otherwise bonded together). The wings (310) traverse the door (20) thickness (t), and align with each second vertical surface (150) vertical edge boundary (180, 190). In other words, the wings (310) ultimately lie flush with the door (20) edge boundaries (180, 190). The U-frame (300) and its wings (310) run the length of the groove (ie the same as length indication arrow l1).

Optionally, in any given embodiment, the U-frame (300) may have integrated therein, hinges (40) to connect the door (20) to the door-frame (30). Otherwise, portions of the wings (310) can provide a cut-out area wherein externally provided (meaning third-party) hinges (40) can be mated.

Also provided in the system (10) second part is an elongate T-frame (320). The T-frame (320) attaches to the door-frame (30) second vertical piece (70). Though not shown, the T-frame (320) can attach to the door-frame (30) by any suitable method, including the same by which the J-frame (50) attaches to the first vertical piece (60) (namely threaded fasteners, nails, etc.—not shown). The T-frame (320) is positionable to extend axially entirely along the second vertical door-frame piece (70), similar to the J-frame (50), the elongate member (130) and the U-frame (300) with wings (310).

Also similar to the U-frame (300) and wings (310), optionally, in any given embodiment, the T-frame (320) may have integrated therein, hinges (40) to connect the door (20) to the door-frame (30). Otherwise, portions (not shown) of the T-frame (320) can provide a cut-out area wherein externally provided (meaning third-party) hinges (40) can be mated. Collectively then, a manufacturer (or assembler) has a number of options as to whether to use integrated hinges (40) on the U-frame (300) wings (310), the T-frame (320), both, or neither (meaning cut-outs are provided and third party hinges (40) are used).

When the U-frame (300) is used in conjunction with the T-frame (320), the T-frame (320) mates with the U-frame (300) when the door is closed. However, this mating is not a “tight” mate. Specifically (and well seen in FIG. 2), the T-frame (320) mates with the U-frame (300) but leaves an axially running (U-shaped) gap (350). This U-shaped gap (350) spans the entire length of the door second vertical surface (150) (ie it somewhat runs parallel, almost concentric-like, to the door (20) second vertical surface (150) recessed groove housing the U-frame (300)). The purpose of leaving that gap (350) between the “T” and the “U” is so that the door (20) can still open and close in normal function. That is, T-frame (320) is positioned to allow the door (20) (within the door frame (30)) to freely open and close when the U-frame (300) is nestled in the door (20) recessed groove and the T-frame (320) mates with the U-frame (300). However, when the T-frame (320) and U-frame (300) are thusly mated (ie with a short “U” gap (350)), this prevents an unwanted entrant from removing door hinges (40), and thereafter prying the door (20) out of its frame (30).

The above-described systems work particularly well for wooden door-frames (30). However, if the user decides to install such a system on a metal door-frame (30), the J-frame (50) cannot be used, as a recessed groove cannot easily be routed into a steel door-frame (30). In that instance, a steel door-frame (30) bracket (generally indicated by reference numeral (360)) and sleeve (generally indicated by reference numeral (370)) combination should be used.

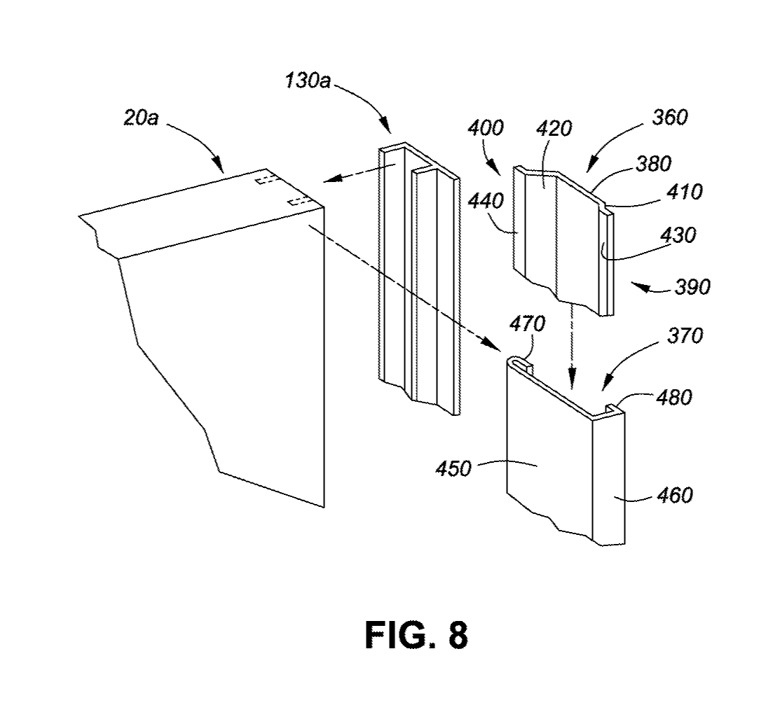

FIGS. 8 and 9 show a bracket (360) and sleeve (370) combination used in place of a J-frame (50). The bracket (360) is a generally planar rectangular member for connecting to the door-frame (30). The rectangular member is bent, and divided into, three sections: a flat rectangular base (380) and two end portions generally indicated by reference numerals (390) and (400) respectively. The first end portion (390) is bent so that it is ultimately parallel to, but elevated away from the base (380). That is, the first end portion (390) initially angles away from the base (380) forming a ramp (410), but is then bent again so that it extends parallel to the base (380), forming a step (430). The second end (400) portion, like the first end portion (390), is bent so that it is ultimately parallel to, but also elevated away the base (380). The second end portion (400) initially angles away from the base (380), forming a ramp (420), but is then bent so that it extends parallel to the base (380), forming another step (440). The two end portions (390, 400) oppose each other in a sense that they are on opposing sides of a rectangle, rather than on adjacent sides of a rectangle. While the first ramp (410) is smaller than the second ramp (420) (in dimension and surface area), the first step (430) can be essentially the same as the second step (440) (in dimension and surface area). In this way, the second end portion (400) is elevated further away from the base (380) than the first end portion (390). The base (380) is contiguous with the two end portions (390, 400) in that the bracket (360) is one solid piece being bent into two ramps (410, 420) and two steps (430, 440), somewhat forming five adjacent rectangular areas.

The sleeve (370) is a second generally planar rectangular member, dimensioned to slide over the bracket (360). This second member is bent to form two arms (450, 460) at right angles, the first arm (450) being longer than the second arm (460), thus forming this second member into an L-shape. The first arm (450) has an end portion, as does the second arm (460). The first arm (450) end portion is bent (roughly toward the second arm (460) end portion) into an arcuate shape to form a hook (470) to slidably receive therein the bracket (360) second step (440). The second arm (460) end portion is bent (roughly toward the first arm (450) end portion) at a right angle forming a square hook (480). The second arm (460) end portion is not really a square per se, but it is bent to be a hook having right angles, and in that sense is referred to as square. The square hook (480) is, when slid over the bracket (360), positioned to receive therein the first step (430), and positioned to be adjacent the first member base (380). Both the arcuate hook (470) and the square hook (480) could be used interchangeably, in that as long as each hook (470, 480) functions to receive each relevant portion of the bracket (360) therein, it does not matter to that end whether an arcuate (470) or square (480) hook is used, on either end portion of the sleeve (370).

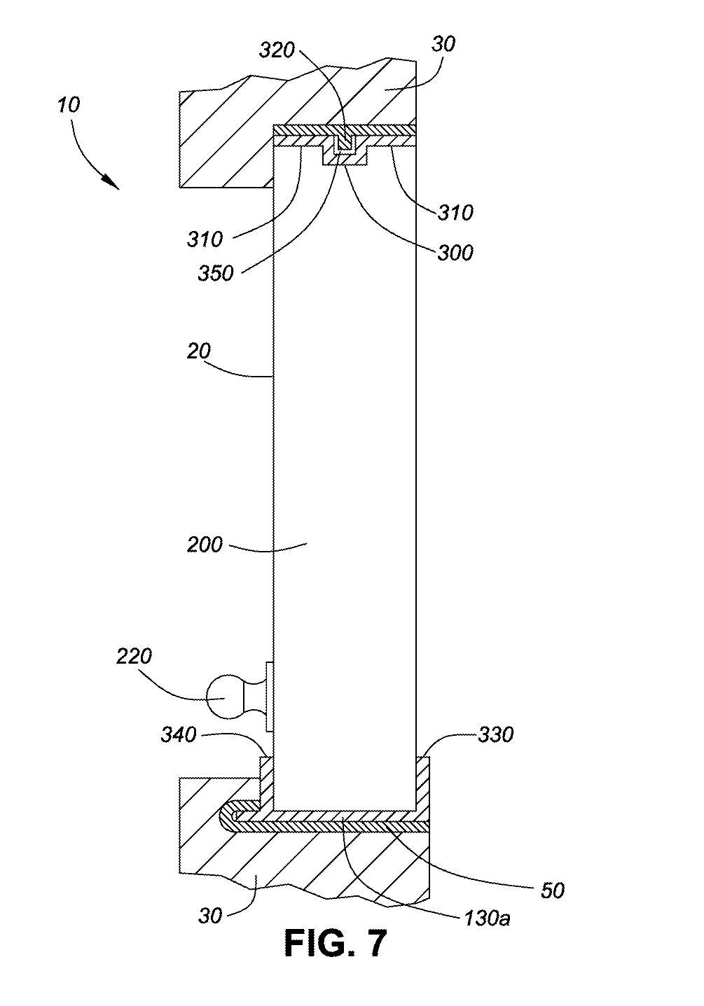

The bracket (360) and sleeve (370) combination, when fastened to a metal door-frame (30), act to produce a receiving area for the F-frame (130a), the same as a J-frame (50) does in a wooden door-frame (30). The distinctions can be seen clearly in FIG. 9 versus FIG. 2 (or versus FIG. 7).

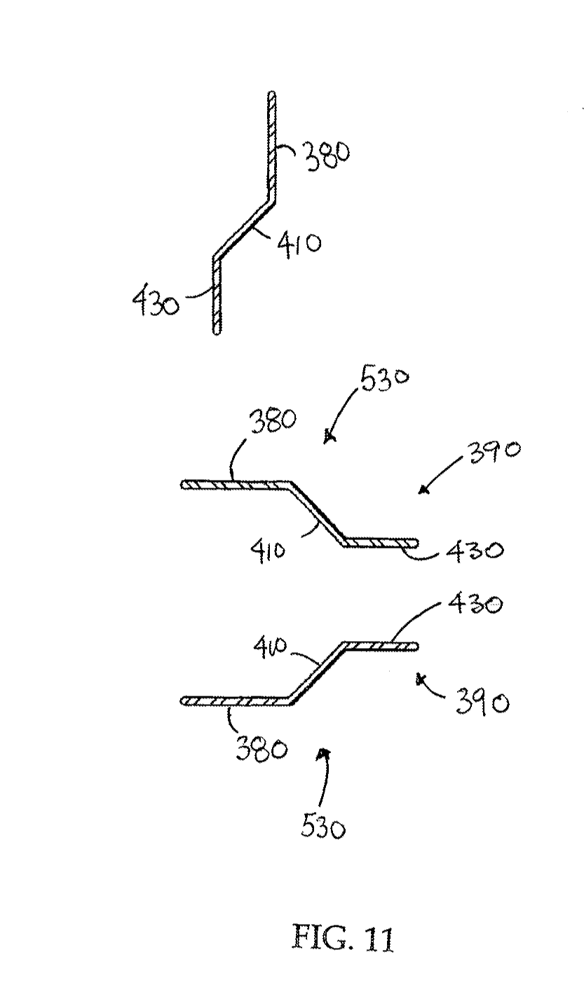

In yet another embodiment the bracket (530) can be simplified (see FIG. 11). The rectangular member is bent, and divided into a flat rectangular base (380) and one end portion generally indicated by reference numeral (390). The first end portion (390) is bent so that it is ultimately parallel to, but elevated away from the base (380). That is, the end portion (390) initially angles away from the base (380) forming a ramp (410), but is then bent again so that it extends parallel to the base (380), forming a step (430). The base (380) is contiguous with the end portion (390) in that the bracket (360) is one solid piece being bent to form a ramp (410) with a single step (430), somewhat forming three adjacent rectangular areas. This simplified bracket (530) can also be used can be used in combination with the sleeve (370) as described above.

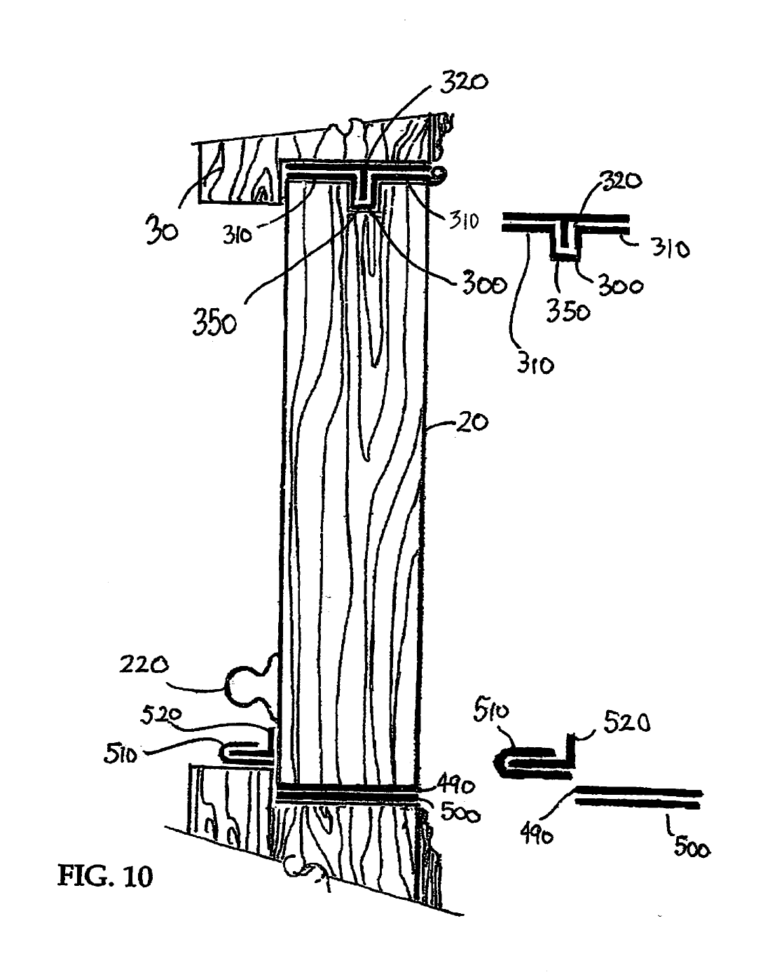

FIG. 10 shows another embodiment of a door (20) and door-frame (30) security system comprising an elongate hook member (510), elongate L-bar member (520), and two flat bars (490, 500). This embodiment allows for the hook member (510) to be attached to an outer side of a door-frame (30), as opposed to being within a recessed groove within the first vertical piece (60) of the door-frame (30). The L-bar member (520) is affixed to an outer side of the door (20), to mate with the hook member (510) when the door (20) is closed.

1. A door-frame security piece comprising:
an elongate J-frame to attach to a door-frame, the door-frame having a) a first and second vertical piece each of a pre-defined door-length, b) a first horizontal piece of a pre-defined door-width, c) a recessed groove defined within the first vertical piece and extending axially therealong, the J-frame being shaped and dimensioned to snugly nestle within and extend entirely along said recessed groove, and the J-frame being positionable to allow a door to freely open and close within said door-frame when the J-channel is nestled in the door-frame groove.

2. A door security piece comprising:
an elongate vertical member to attach to a door, the door having a) a first and second vertical surface each being a pre-defined door length, each defining two vertical edge boundaries, b) a first and second horizontal surface being a pre-defined door width, c) each vertical surface vertical edge boundaries defining a door thickness, the elongate member being attachable to the door first vertical surface to entirely cover same and traverse at least the door thickness.

3. The door security piece in claim 2 wherein the elongate member defines at least one opening to allow at least one door bolt to pass therethrough.

4. The door security piece in claim 2 wherein the elongate member defines at least one opening to pass at least one fastener therethrough.

5. The door security piece in claim 2 wherein the elongate member is an F-frame.

6. The door security piece in claim 2 wherein the elongate member is a U-frame.

7. The door security piece in claim 2 wherein the elongate member is a T-frame.

8. The door security piece in claim 2 wherein the elongate member is an L-frame.

9. The door security piece in claim 2 wherein the elongate vertical member aligns with the door first vertical surface second vertical edge boundary.

10. A door security piece comprising:
an elongate U-frame to attach to a door, the door having a) a first and second vertical surface each of a pre-defined door-length, each defining two vertical edge boundaries, b) a first and second horizontal surface each of a pre-defined door-width, c) a recessed groove defined within the second vertical surface extending axially therealong, d) each vertical surface vertical edge boundaries defining a door thickness, the U-frame being shaped and dimensioned to snugly nestle within and extend entirely along said recessed groove, and the U-frame being positionable to allow the door within said door frame to freely open and close when the U-frame is nestled in the door recessed groove.

11. The door security piece in claim 10 further comprising wings attached to the U-frame, the wings traversing the door thickness and aligning with each second vertical surface vertical edge boundary.

12. The door security piece in claim 10 further comprising a door hinge plate integrated into the U-frame.

13. A door-frame security piece comprising:
an elongate T-frame to attach to a door-frame, the door-frame having a) a first and second vertical piece each of a pre-defined door-length, b) a first horizontal piece of a pre-defined door-width, the T-frame being positionable to extend axially entirely along the second vertical door-frame piece.

14. The door-frame security piece in claim 13 further comprising a door hinge plate integrated into the T-frame.

15. A door security system comprising:
an elongate J-frame to attach to a door-frame, the door-frame having a) a first and second vertical piece each of a pre-defined door-length, b) a first horizontal piece of a pre-defined door-width, c) a recessed groove defined within the first vertical piece extending axially therealong, the J-frame being shaped and dimensioned to snugly nestle within and extend entirely along said recessed groove, and the J-frame being positionable to allow a door, the door having a) a first and second vertical surface each being a pre-defined door length, each defining two vertical edge boundaries, b) a first and second horizontal surface being a pre-defined door width, c) each vertical surface vertical edge boundaries defining a door thickness, to freely open and close within said door-frame when the J-channel is nestled in the door-frame groove; and
an elongate vertical member attached to the door first vertical surface to entirely cover same and traverse at least the door thickness.

16. The door security system in claim 15 wherein the elongate vertical member defines at least one opening to allow at least one door bolt to pass therethrough.

17. The door security system in claim 15 wherein the elongate vertical member defines at least one opening to pass at least one fastener therethrough.

18. The door security system in claim 15 wherein the elongate vertical member is an F-frame.

19. The door security system in claim 15 wherein the elongate vertical member is a U-frame.

20. The door security system in claim 15 wherein the elongate vertical member is a T-frame.

21. The door security system in claim 15 wherein the elongate vertical member is an L-frame.

22. The door security system in claim 15 wherein the elongate vertical member aligns with the first vertical surface second vertical edge boundary.

23. The door security system in claim 15 wherein the elongate vertical member mates with the J-frame when the door is closed.

24. A door security system comprising:
an elongate U-frame to attach to a door, the door having a) a first and second vertical surface each of a pre-defined door-length, each defining two vertical edge boundaries, b) a first and second horizontal surface each of a pre-defined door-width, c) a recessed groove defined within the second vertical surface extending axially therealong, d) each vertical surface vertical edge boundaries defining a door thickness, the U-frame being shaped and dimensioned to snugly nestle within and extend entirely along said recessed groove, and the U-frame being positionable to allow the door to freely open and close within a door frame when the U-frame is nestled in the door recessed groove; and
an elongate T-frame to attach to the door-frame, the door-frame having a) a first and second vertical piece each of the pre-defined door-length, b) a first horizontal piece of the pre-defined door-width, the T-frame being positionable to extend axially entirely along the second vertical door-frame piece.

25. The door security system in claim 24 further comprising wings attached to the U-frame, the wings traversing the door thickness and aligning with each second vertical surface vertical edge boundary.

26. The door security system in claim 24 further comprising a door hinge plate integrated into the U-frame.

27. The door security system in claim 24 further comprising a door hinge plate integrated into the T-frame.

28. The door security system in claim 24 wherein the T-frame mates with the U-frame when the door is closed.

29. A method to prevent forcible entry, said method comprising:
using an elongate J-frame in a door-security system wherein the elongate J-frame is nestled into a recessed groove axially traversing a door-frame vertical surface; and extending the J frame entirely along the recessed groove.

30. A method to prevent forcible entry, said method comprising:
using an elongate vertical member in a door-security system, wherein the elongate vertical member is attached to a door vertical surface, entirely covering and traversing same.

31. The method to prevent forcible entry in claim 30, wherein the elongate vertical member is an F-frame.

32. The method to prevent forcible entry in claim 30, wherein the elongate vertical member is a U-frame.

33. The method to prevent forcible entry in claim 30, wherein the elongate vertical member is a T-frame.

34. The method to prevent forcible entry in claim 30, wherein the elongate vertical member is an L-frame.

35. A method to prevent forcible entry, said method comprising:
using an elongate U-frame in a door-security system wherein the U-frame is nestled into a recessed groove axially traversing a door vertical surface; and
extending the U frame entirely along the recessed groove.

36. The method to prevent forcible entry in claim 35, further comprising:
attaching wings to the U-frame, the wings traversing a door thickness and aligning with door vertical surface vertical edge boundaries.

37. A method to prevent forcible entry, said method comprising:
using an elongate T-frame in a door-security system, wherein the T-frame extends axially entirely along a door-frame vertical piece.

38. A door-frame bracket comprising:
a planar rectangular member bent and divided into a flat rectangular base and two end portions, the first end portion being parallel to and elevated away from the base, the second end portion being parallel to and elevated away the base, the two end portions opposing each other, the base being contiguous with the two end portions, the second end portion being elevated further away from the base than the first end portion.

39. A door-frame sleeve comprising:
a planar rectangular member bent to form two arms at right angles, the first arm being longer than the second arm, forming the member into an L-shape, the first arm having an end portion, the second arm having an end portion, the first arm end portion being bent toward the second arm end portion to form a first hook, and the second arm end portion being bent toward the first arm end portion to form a second hook.

40. A door-frame bracket and sleeve combination comprising:
a planar rectangular member for connecting to a door-frame, the rectangular member being bent and divided into a flat rectangular base and two end portions, the first end portion being parallel to and elevated away from the base, the second end portion being parallel to and elevated away the base, the two end portions opposing each other, the base being contiguous with the two end portions, and the second end portion being elevated further away from the base than the first end portion; and
a second planar rectangular member to slide over the first member as a sleeve, the second member being bent to form two arms at right angles, the first arm being longer than the second arm, forming the second member into an L-shape, the first arm having an end portion, the second arm having an end portion, the first arm end portion being bent toward the second arm end portion to form a first hook, to slidably receive therein the first member second end portion, and the second arm end portion being bent toward the first arm end portion to form a second hook, and positioned to receive therein the first member first end portion, and positioned to be adjacent the first member base when slid over the first rectangular member.

41. The door-frame sleeve in claim 39 wherein the first arm end portion is bent to form one selected from a group comprising an arcuate and square first hook.

42. The door-frame sleeve in claim 39 wherein the second arm end portion is bent to form one selected from a group comprising an arcuate and square second hook.

43. The door-frame bracket and sleeve combination in claim 40 wherein the first arm end portion is bent to form one selected from a group comprising an arcuate and square first hook.

44. The door-frame bracket and sleeve combination in claim 40 wherein the second arm end portion is bent to form one selected from a group comprising an arcuate and square second hook.

45. A door-frame bracket comprising:
a planar rectangular member bent and divided into a flat rectangular base and an end portion, the end portion being parallel to and elevated away from the base, the base being contiguous with the end portion.

46. A door-frame bracket and sleeve combination comprising:
a planar rectangular member for connecting to a door-frame, the rectangular member being bent and divided into a flat rectangular base and an end portion, the end portion being parallel to and elevated away from the base, the base being contiguous with the end portion; and
a second planar rectangular member to slide over the first member as a sleeve, the second member being bent to form two arms at right angles, the first arm being longer than the second arm, forming the second member into an L-shape, the first arm having an end portion, the second arm having an end portion, the first arm end portion being bent toward the second arm end portion to form a first hook, to slidably receive therein the first member base, and the second arm end portion being bent toward the first arm end portion to form a second hook, and positioned to receive therein the first member end portion, and positioned to be adjacent the first member base when slid over the first rectangular member.
